(19) United States
(12) Patent Application Publication
(10) Pub. No.: US 2022/0025122 A1
(43) Pub. Date: Jan. 27, 2022

(54) COMPOSITION INCLUDING A POLYTHIOL, AN UNSATURATED COMPOUND, AND A FILLER AND A TWO-PART COMPOSITION MADE THEREFROM

(71) Applicant: 3M INNOVATIVE PROPERTIES COMPANY, St. Paul, MN (US)

(72) Inventors: Yu Yang, Eden Prairie, MN (US); Ruijian Xu, Woodbury, MN (US); Mark F. Schulz, Lake Elmo, MN (US); Nikki D. McRae-Brown, Inver Grove Heights, MN (US); Ken Nakatani, Woodbury, MN (US); Andrew D. Norlander, Woodbury, MN (US)

(21) Appl. No.: 17/276,258

(22) PCT Filed: Sep. 18, 2019
(86) PCT No.: PCT/IB2019/057874

§ 371 Date: Mar. 15, 2021

Related U.S. Application Data
(60) Provisional application No. 62/733,473, filed on Sep. 19, 2018.

(51) Int. Cl. C08G 75/045; C08K 5/14; C09D 181/02; C08K 5/101; C09D 7/63; C08K 3/013

(52) U.S. Cl. CPC C08G 75/045; C08K 5/14; C08K 3/013; C08K 5/101; C09D 7/63; C09D 181/02

(57) ABSTRACT

The composition includes a polythiol having more than one thiol group and an allylic resin having more than one allyl group. The composition typically includes inorganic filler. Typically, at least one of the polythiol or the allylic resin has more than two thiol or allyl groups, respectively. A two-part body repair composition including the composition and use of the composition as a body repair composition are also disclosed. Methods of repairing a damaged surface are also disclosed. The method can include combining a composition with at least one of an organic peroxide or hydroperoxide, applying the composition including at least one of the organic peroxide or the organic hydroperoxide to the damaged surface, and curing the composition on the damaged surface to provide a cured composition. The composition includes a polythiol having more than one thiol group, an allylic compound having more than one allyl group, and inorganic filler.

### CROSS-REFERENCE TO RELATED APPLICATION

This application claims priority to U.S. Provisional Application No. 62/733,473, filed Sep. 19, 2018, the disclosure of which is incorporated by reference in its entirety herein.

### BACKGROUND

Automobile body repair is often carried out with a body repair compound, also called body filler. A body repair compound can include a thermosetting resin, fillers, promoters, and other additives that are mixed with a catalyst to facilitate cross-linking at room temperature. After mixing, a technician spreads the body filler onto a damaged surface, allows the body filler to harden, and then sands the hardened body filler to conform to the desired surface contour. The process can be repeated two or more times until the damaged area of the vehicle is sufficiently filled, and the contour of the original surface is matched.

Automotive body fillers often include unsaturated polyester resins. Unsaturated polyester resins typically contain α,β-unsaturated polyesters and 30 to 50 percent by weight copolymerizable monomers. Styrene, due to its well-understood reactivity profiles with unsaturated polyester resins and other monomers and its relatively low cost, is by far the dominant copolymerizable monomer used in unsaturated polyester resins. Body fillers including unsaturated polyester resins and styrene are known to cure well in the presence of oxygen. However, styrene has a relatively high volatility which results in its being released from both uncured resins at room temperature and at much higher rates during cure. The Environmental Protection Agency (EPA) included styrene in its Toxic Release Inventory (TRI) in 1987 and classifies it as a possible carcinogen. Organizations such as the Occupational Safety and Health Administration (OSHA) and the Clean Air Act Amendments (CAAA) have included styrene in a list of volatile organic compounds to which exposure should be limited.

Some styrene-free body filler compositions have been described. See, for example, JP2005255937, published Sep. 22, 2005, and U.S. Pat. No. 5,068,125 (Meixner et al.). A visible-light polymerizable thiol-ene composition useful as a body filler is described in U.S. Pat. No. 5,876,805 (Ostlie).

### SUMMARY

Some options for replacing styrene in body filler compositions result in unacceptable surface tackiness, poor spreadability, and poor adhesion to metals. The present disclosure provides a composition that, when cured, provides a non-tacky surface in the presence of oxygen. The composition is useful as a body filler, for example, that can be prepared, applied, cured, and sanded using processes familiar to those in the body repair industry.

In one aspect, the present disclosure provides a composition that includes a polythiol having more than one thiol group and an allylic resin having more than one allyl group. The composition typically includes inorganic filler. Typically, at least one of the polythiol or the allylic resin has more than two thiol or allyl groups, respectively.

In another aspect, the present disclosure provides a two-part body repair composition, wherein a first part includes the composition described above, and a second part includes at least one of an organic peroxide or organic hydroperoxide.

In another aspect, the present disclosure provides an article prepared from the two-part body repair composition by combining the first part and the second part and curing the composition.

In another aspect, the present disclosure provides the use of the composition described above as a body repair composition.

In another aspect, the present disclosure provides a method of repairing a damaged surface. The method includes combining the composition described above with at least one of an organic peroxide or an organic hydroperoxide, applying the composition including at least one of the organic peroxide or the organic hydroperoxide to the damaged surface; and curing the composition on the damaged surface to provide a cured composition.

In another aspect, the present disclosure provides use of a composition as a body repair composition. The composition includes a polythiol having more than one thiol group, an allylic compound having more than one allyl group, and inorganic filler. A number of the thiol groups is within 20 percent of a number of the allyl groups. At least one of the polythiol or the allylic compound has more than two thiol or allyl groups, respectively. The composition can be packaged as a two-part body repair composition in which the first part includes the composition and the second part includes an at least one of an organic peroxide or organic hydroperoxide. The composition can be substantially free of photoinitiator.

In another aspect, the present disclosure provides a method of repairing a damaged surface. The method includes combining a composition with at least one of an organic peroxide or an organic hydroperoxide, applying the composition including at least one of the organic peroxide or the organic hydroperoxide to the damaged surface, and curing the composition on the damaged surface to provide a cured composition. The composition includes a polythiol having more than one thiol group, an allylic compound having more than one allyl group, and inorganic filler. A number of the thiol groups is within 20 percent of a number of the allyl groups. At least one of the polythiol or the allylic compound has more than two thiol or allyl groups, respectively. Curing can be carried out at room temperature. The method can further include sanding the cured composition.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility but may be swellable in the presence of an appropriate solvent.

The term “polymer or polymeric” will be understood to include polymers, copolymers (e.g., polymers formed using two or more different monomers), oligomers or monomers that can form polymers, and combinations thereof, as well as polymers, oligomers, monomers, or copolymers that can be blended.

A “resin” refers to an oligomer or polymer that undergoes further reaction to form a crosslinked network. The reaction used to make the allylic resin may be an ene-thiol reaction or may not be an ene-thiol reaction. In some embodiments, the reaction used to make the allylic resin is not an ene-thiol reaction.

“Alkyl group” and the prefix “alk-” are inclusive of both straight chain and branched chain groups and of cyclic groups. In some embodiments, alkyl groups have up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms. Terminal “alkenyl” groups have at least 3 carbon atoms.

“Alkylene” is the multivalent (e.g., divalent or trivalent) form of the “alkyl” groups defined above.

“Arylalkylene” refers to an “alkylene” moiety to which an aryl group is attached. “Alkylarylene” refers to an “arylene” moiety to which an alkyl group is attached.

The terms “aryl” and “arylene” as used herein include carbocyclic aromatic rings or ring systems, for example, having 1, 2, or 3 rings and optionally containing at least one heteroatom (e.g., O, S, or N) in the ring. Unless otherwise specified, aryl groups may have up to five substituents independently selected from the group consisting of alkyl groups having up to 4 carbon atoms (e.g., methyl or ethyl), alkoxy having up to 4 carbon atoms, halo (i.e., fluoro, chloro, bromo or iodo), hydroxy, or nitro groups. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term “heterocyclyl” includes non-aromatic rings or ring systems that contain at least one ring heteroatom (e.g., O, S, N). The heterocyclyl group may include 1, 2, or 3 rings and includes all of the fully saturated and partially unsaturated derivatives of the above-mentioned aryl groups having at least one heteroatom.

An allyl group is a H₂C═CH—CH₂— group. To distinguish from other terminal olefins, the CH₂ group in the allyl group is attached to a group other than another CH₂ group. Typically, the CH₂ group in the allyl group is attached to a heteroatom (e.g., O, S, or N), but it also may be attached to an aromatic ring or carbonyl group, for example.

A “volatile organic compound” is a compound having at least one carbon atom that participates in atmospheric photochemical reactions. Unless otherwise specified, a volatile organic compound has at least one of a vapor pressure greater than 0.1 mm Hg at 20° C. or a boiling point of less than 216° C.

Flash point is determined by the ASTM D93 Pensky-Martens method.

The term “ceramic” refers to glasses, crystalline ceramics, glass-ceramics, and combinations thereof.

All numerical ranges are inclusive of their endpoints and non-integral values between the endpoints unless otherwise stated (e.g., 1 to 5 includes 1, 1.5, 2, 2.75, 3, 3.80, 4, 5, etc.).

### DETAILED DESCRIPTION

A variety of polythiols may be useful in the compositions according to the present disclosure. In some embodiments, the polythiol has a molecular weight of up to 500 grams per mole. In these embodiments, the polythiol may be an alkylene, arylene, alkylarylene, arylalkylene, or alkylenearylalkylene having more than one mercaptan group, wherein any of the alkylene, alkylarylene, arylalkylene, or alkylenearylalkylene are optionally interrupted by one or more ether (i.e., —O—), thioether (i.e., —S—), amine (i.e., —NR¹—), or ester (—C(O)—O—) groups and optionally substituted by alkoxy or hydroxyl. Useful polythiols having a molecular weight of up to 500 grams per mole may be dithiols or polythiols with more than 2 (in some embodiments, 3 or 4) mercaptan groups. In some embodiments, the polythiol is an alkylene dithiol in which the alkylene is optionally interrupted by one or more ether (i.e., —O—) or thioether (i.e., —S—) groups. Examples of useful dithiols include 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide, methyl-substituted dimercaptodiethylsulfide, dimethyl-substituted dimercaptodiethylsulfide, dimercaptodioxaoctane, 1,5-dimercapto-3-oxapentane and mixtures thereof. Polythiols having more than two mercaptan groups include propane-1,2,3-trithiol; 1,2-bis[(2-mercaptoethyl)thio]-3-mercaptopropane; tetrakis(7-mercapto-2,5-dithiaheptyl)methane; and trithiocyanuric acid.

In some embodiments, the polythiol comprises ester groups. In some embodiments, the polythiol is multifunctional alkylene thiol in which the alkylene is optionally interrupted by one or more ester (i.e., —C(O)O—) groups. Such polythiols can be formed from the esterification of polyols with thiol-containing carboxylic acids or their derivatives. Examples of polythiols formed from the esterification of polyols with thiol-containing carboxylic acids or their derivatives include those made from the esterification reaction between thioglycolic acid or 3-mercaptopropionic acid and several polyols to form the mercaptoacetates or mercaptopropionates, respectively. For example, esters of thioglycolic acid, α-mercaptopropionic acid, and f3-mercaptopropionic acid with polyhydroxy compounds (polyols) such as diols (e.g., glycols), triols, tetraols, pentaols, and hexaols. Specific examples of such polythiols include, but are not limited to, ethylene glycol bis(thioglycolate), ethylene glycol bis(β-mercaptopropionate), trimethylolpropane tris(thioglycolate), trimethylolpropane tris(β-mercaptopropionate) and ethoxylated versions, pentaerythritol tetrakis(thioglycolate), pentaerythritol tetrakis(β-mercaptopropionate), and tris(hydroxyethyl)isocyanurate tris(β-mercaptopropionate). Combinations of any of these or with any of the dithiols mentioned above may be useful.

Examples of useful commercially available polythiols include those available under the trade designations THIOCURE PETMP (pentaerythritol tetra(3-mercaptopropionate)), TMPMP (trimethylolpropane tri(3-mercaptopropionate)), ETTMP (ethoxylated trimethylolpropane tri(3-mercaptopropionate) such as ETTMP 1300 and ETTMP 700), GDMP glycol di(3-mercaptopropionate), TMPMA (trimethylolpropane tri(mercaptoacetate)), TEMPIC (tris[2-(3-mercaptopropionyloxy)ethyl] isocyanurate), and PPGMP (propylene glycol 3-mercaptopropionate) from Bruno Bock Chemische Fabrik GmbH & Co. KG. Other examples include the 3-mercaptopropionates (also referred to as β-mercaptopropionates) of ethylene glycol and trimethylolpropane (the former from Chemische Fabrik GmbH & Co. KG, the latter from Sigma-Aldrich).

While polythiols comprising ester groups are useful in the body repair compositions of the present disclosure, they are often avoided in other products that require hydrolytic stability (e.g., sealants used in the construction of aircraft).

In some embodiments, the polythiol in the composition according to the present disclosure has a number average molecular weight of greater than 500 grams per mole, in some embodiments, at least 1000 grams per mole. In these embodiments, the polythiol can be oligomeric or polymeric. Examples of useful oligomeric or polymeric polythiols include polythioethers and polysulfides. Polythioethers include thioether linkages (i.e., —S—) in their backbone structures. Polysulfides include disulfides linkages (i.e., —S—S—) in their backbone structures.

Polythioethers can be prepared, for example, by reacting dithiols with dienes, diynes, divinyl ethers, diallyl ethers, ene-ynes, or combinations of these under free-radical conditions. Useful reagents for making polythioethers include dithiols (e.g., any of the dithiols listed above) and divinyl ethers. Trifunctional monomers can be useful for providing branching in the polythioether. Useful vinyl ethers having two or more vinyl ether groups include divinyl ether, ethylene glycol divinyl ether, butanediol divinyl ether, hexanediol divinyl ether, diethylene glycol divinyl ether, triethylene glycol divinyl ether, tetraethylene glycol divinyl ether, cyclohexanedimethanol divinyl ether, polytetrahydrofuryl divinyl ether, trimethylolpropane trivinyl ether, pentaerythritol tetravinyl ether, and combinations of any of these. Useful divinyl ethers of formula CH₂═CH—O—(—R²—O—)ₘ—CH═CH₂, in which R² is C₂ to C₆ branched alkylene can be prepared by reacting a polyhydroxy compound with acetylene. Examples of compounds of this type include compounds in which R² is an alkyl-substituted methylene group such as —CH(CH₃)— (e.g., those obtained from BASF, Florham Park, N.J, under the trade designation “PLURIOL”, for which R² is ethylene and m is 3.8) or an alkyl-substituted ethylene (e.g., —CH₂CH(CH₃)— such as those obtained from International Specialty Products of Wayne, N.J., under the trade designation “DPE” (e.g., “DPE-2” and “DPE-3”).

Examples of useful polythioethers are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.). In some embodiments, the polythioether is represented by formula HS—R³—[S—(CH₂)₂—O—[—R⁴—O—]ₘ—(CH₂)₂—S—R³—]ₙ—SH, wherein each R³ and R⁴ is independently a C₂₋₆ alkylene, which may be straight-chain or branched, C₆₋₈ cycloalkylene, C₆₋₁₀ alkylcycloalkylene, or —[(CH₂—)ₚ—X—]_{q}+CH₂—)ᵣ, in which at least one —CH₂— is optionally substituted with a methyl group, X is selected from the group consisting of 0, S and —NR⁵—, R⁵ denotes hydrogen or methyl, m is a number from 0 to 10, n is a number from 1 to 60, p is a number from 2 to 6, q is a number from 1 to 5, and r is a number from 2 to 10. Polythioethers with more than two mercaptan groups may also be useful. Preparing the polythioethers may be carried out by combining the dithiol with the diene, diyne, divinyl ether, diallyl ether, ene-yne, or combinations of these and a thermal initiator, and the resulting mixture can heated to provide the polythioethers. Suitable thermal initiators include azo compounds (e.g., 2,2′-azobisisobutyronitrile (AIBN), 2,2′-azobis(2-methylbutyronitrile), or azo-2-cyanovaleric acid) and any of the peroxides or hydroperoxides described below. Preparing the polythioethers may also be carried out using a photoinitiator (e.g., any of those described below) and exposing the reaction to light.

Polythioethers can also be prepared, for example, by reacting dithiols with diepoxides, which may be carried out by stirring at room temperature, optionally in the presence of a tertiary amine catalyst (e.g., 1,4-diazabicyclo[2.2.2]octane (DABCO)). Useful dithiols include any of those described above. Useful epoxides can be any of those having two epoxide groups. In some embodiments, the diepoxide is a bisphenol diglycidyl ether, wherein the bisphenol (i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. Polythioethers prepared from dithiols and diepoxides have pendent hydroxyl groups and can have structural repeating units represented by formula —S—R³—S—CH₂—CH(OH)—CH₂—O—C₆H₅—CH₂—C₆H₅—O—CH₂—CH(OH)—CH₂—S—R³—S—, wherein R³ is as defined above, and the bisphenol unit (i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. Mercaptan terminated polythioethers of this type can then optionally be reacted with any of the dienes, diynes, divinyl ethers, diallyl ethers, and ene-ynes listed above under free radical conditions. Any of the free-radical initiators and methods described below in connection with at least partially curing the composition disclosed herein may also be useful for preparing the polythioethers. In some embodiments, a thermal initiator described below is used, and the resulting mixture is heated to provide the polythioether.

Polysulfides are typically prepared by the condensation of sodium polysulfide with bis-(2-chloroethyl) formal, which provides linear polysulfides having two terminal mercaptan groups. Branched polysulfides having three or more mercaptan groups can be prepared using trichloropropane in the reaction mixture. Examples of useful polysulfides are described, for example, in U.S. Pat. No. 2,466,963 (Patrick et al); U.S. Pat. No. 2,789,958 (Fettes et al); U.S. Pat. No. 4,165,425 (Bertozzi); and U.S. Pat. No. 5,610,243 (Vietti et al.). Polysulfides are commercially available under the trademarks “THIOKOL” and “LP” from Toray Fine Chemicals Co., Ltd., Urayasu, Japan and are exemplified by grades “LP-2”, “LP-2C” (branched), “LP-3”, “LP-33”, and “LP-541”.

Polythioethers and polysulfides can have a variety of useful molecular weights. In some embodiments, the polythioethers and polysulfides have number average molecular weights in a range from 500 grams per mole to 20,000 grams per mole, 1,000 grams per mole to 10,000 grams per mole, or 2,000 grams per mole to 5,000 grams per mole. Number average molecular weights can be determined, for example, by nuclear magnetic resonance spectroscopy and gel permeation chromatography. Mixtures of polythioethers or polysulfides with any of the other polythiols described above may be useful.

Another example of a polymeric or oligomeric polythiol is polypropylene-ether glycol bis(β-mercaptopropionate), which is prepared from polypropylene-ether glycol (e.g., PLURACOL P201, Wyandotte Chemical Corp.) and β-mercaptopropionic acid by esterification.

Further useful polythiols include those prepared from a ring-opening reaction of epoxides with H₂S (or its equivalent), those prepared from the addition of H₂S (or its equivalent) across carbon-carbon double bonds, POLYMERCAPTAN 805C (mercaptanized castor oil); POLYMERCAPTAN 407 (mercaptohydroxy soybean oil) from Chevron Phillips Chemical Co. LLP, and CAPCURE, specifically CAPCURE 3-800 (a polyoxyalkylenetriol with mercapto end groups of the structure R⁵[O(C₃H₆O)ₙCH₂CH(OH)CH₂SH]₃ wherein R⁵ represents an aliphatic hydrocarbon group having 1-12 carbon atoms and n is an integer from 1 to 25), from Gabriel Performance Products, Ashtabula, Ohio, and GPM-800, which is equivalent to CAPCURE 3-800, also from Gabriel Performance Products.

The polythiol, regardless of molecular weight, may have more than two (e.g., at least three or four) thiol groups. In some embodiments in which mixtures of polythiols are employed, it may be useful to include at least 5 percent by weight of polythiols having at least three thiol groups, based on the total weight of the polythiol in the composition.

The composition of the present disclosure incudes an allylic compound. The allylic compound may be allyl ether or an alkylene, arylene, alkylarylene, arylalkylene, or alkylenearylalkylene having more than one allyl group, wherein any of the alkylene, alkylarylene, arylalkylene, or alkylenearylalkylene are optionally interrupted by one or more ether (i.e., —O—), thioether (i.e., —S—), amine (i.e., —NR¹—), or ester (—C(O)—O—) groups and optionally substituted by alkoxy or hydroxyl. Useful allylic compounds may be difunctional or may have more than 2 (in some embodiments, 3 or 4) allyl groups. In some embodiments, the allylic compound has a molecular weight of up to 500 grams per mole. Examples of useful allylic compounds having a molecular weight of up to 500 grams per mole include allyl ether, diallyl phthalate, triallyl-1,3,5-triazine-2,4,6-trione, 2,4,6-triallyloxy-1,3,5-triazine, trimethylolpropane diallyl ether, and diallyl ethers of bisphenols (e.g., ortho-diallyl ether of bisphenol A).

In some embodiments, the composition according to the present disclosure includes an allylic resin comprising more than one allyl group. In these embodiments, the allyl compound described above comprises the allylic resin. The allylic resin can include 2, 3, 4, 5, or more allyl groups. The allylic resin can be an allylic functional aliphatic oligomer, an allylic functional polyurethane, an allylic functional polyester, an allylic functional polyether, a diallyl phthalate resin, or an allylic functional polythioether. Many of these allylic resins are commercially available. For example, allylic functional aliphatic oligomers are commercially available from Sartomer, USA, LLC Exton, Penn., under the trade designations, for example, “CN9101” and “CN9102”. Allylic functional polythioethers can be made with the methods described above using an excess of diallyl ether, for example. The methods described in U.S. Pat. No. 5,741,884 (Cai et al.) and U.S. Pat. No. 9,920,006 (Cui et al.) may also be useful. In these cases, the reaction used to make the allylic resin may be an ene-thiol reaction. In other cases, the reaction used to make the allylic resin is not an ene-thiol reaction. Polythioether allylic resins can also be made by reaction of diallyl ether with hydrogen sulfide, for example, using the methods described in U.S. Pat. No. 2,522,589 (Vaughan et al.) and U.S. Pat. No. 2,522,512 (Harman et al.). In other cases, the allylic resin may be substantially free of sulfur atoms. Substantially free of sulfur atoms means the allylic resin may be free of sulfur atoms or can have less than five, four, three, two, one, 0.5, 0.25, 0.1, 0.05, or 0.01 percent sulfur atoms, based on the total weight of the allylic resin. In some embodiments, the allylic resin may be substantially free of hydroxyl groups. Substantially free of hydroxyl groups means the allylic resin may be free of hydroxyl groups or can have less than five, four, three, two, one, 0.5, 0.25, 0.1, 0.05, or 0.01 percent hydroxyl groups, based on the total weight of the allylic resin.

Allylic resins useful for practicing the present disclosure can have a variety of useful molecular weights. In some embodiments, the allylic resins have number average molecular weights in a range from 500 grams per mole to 20,000 grams per mole, 500 grams per mole to 10,000 grams per mole, or 500 grams per mole to 5,000 grams per mole. Number average molecular weights can be determined, for example, by nuclear magnetic resonance spectroscopy and gel permeation chromatography.

The allylic resin, allylic compound, or mixture thereof may have more than two (e.g., at least three or four) allyl groups. For mixtures of allylic resins and/or other allylic compounds described above, it may be useful to include at least 5 percent by weight of compounds having at least three allyl groups, based on the total weight of the allylic resin and/or allylic compound in the composition.

Advantageously, when an organic peroxide and hydroperoxide is added to a composition including a polythiol and allylic compound (e.g., allylic resin), the composition remains spreadable for about useful time period but can cure at room temperature in air to provide a non-tacky cured composition also in a useful time period. By contrast, little or no curing was observed when polybutadiene was used instead of the allylic compound as shown in Illustrative Example 4 in the Examples, below. Acrylates and vinyl ethers may cure too quickly with thiols, thereby shortening the spreadability time such that the composition cannot be easily spread on a surface.

Typically, the amounts of the polythiol(s) and allylic compound(s) are selected for the composition so that there is a stoichiometric equivalence of mercaptan and allyl groups, and a number of the thiol groups is within 20 percent of a number of the allyl groups. In some embodiments, a number of the thiol groups is within 20, 15, 10, or 5 percent of a number of the allyl groups. In the event that the molecular weight of either of the components is not known with accuracy, combinations of components in a few ratios believed to be close to one-to-one may be cured to evaluate gel time, solidification time, and tackiness.

In some embodiments, the composition of the present disclosure includes an unsaturated compound having more than one carbon-carbon double bond and/or at least one carbon-carbon triple bond other than the allylic compound or allylic resin. In some embodiments, the unsaturated compound has a molecular weight of up to 500 grams per mole and may be considered monomeric. These compounds can serve as reactive diluents to adjust the viscosity of the composition. The unsaturated compound may also include one or more ether (i.e., —O—), thioether (i.e., —S—), amine (i.e., —NR¹—), or ester (e.g., so that the compound is an acrylate or methacrylate) groups and one or more alkoxy or hydroxyl substituents. In some embodiments, the unsaturated compound does not include ester groups or carbonate groups. That is, in these embodiments, the unsaturated compound is not an acrylate, methacrylate, vinyl ester, or vinyl carbonate. Unsaturated compounds without ester and carbonate groups may be more chemically stable than unsaturated compounds that contain these groups. Suitable unsaturated compounds include dienes, alkynes, diynes, divinyl ethers, ene-ynes, and trifunctional versions of any of these. Combinations of any of these groups may also be useful. Examples of suitable vinyl ethers having two or more vinyl ether groups include any of those described above in connection with the preparation of polythioethers. Other suitable examples of unsaturated compounds having more than one carbon-carbon double bond or carbon-carbon triple bond include 1,2,4-trivinyl cyclohexane, and allyl methacrylate. In some cases, it can be useful to include standard unsaturated resins in the composition, for example, unsaturated polyester resins or vinyl ester resins. However, compositions excluding these resins have good curing properties as shown in the Examples, below.

The composition according to the present disclosure and/or useful for practicing the present disclosure also typically includes inorganic filler. In some embodiments, the composition according to the present disclosure includes at least one of ceramic beads, silica, hollow ceramic elements, alumina, zirconia, mica, dolomite, wollastonite, fibers, talc, calcium carbonate, sodium metaborate, or clay. Such fillers, alone or in combination, can be present in the composition according to the present disclosure in a range from 10 percent by weight to 70 percent by weight, in some embodiments, 20 percent by weight to 60 percent by weight or 40 percent by weight to 60 percent by weight, based on the total weight of the composition. The presence of inorganic filler can be useful, for example, for deceasing surface tackiness and facilitating sanding in the cured composition. Compositions according to the present disclosure can also include dyes, pigments, rheology modifiers (e.g., fumed silica or clay), polymer beads, or hollow polymer elements.

Silica, alumina, and zirconia, for example, can be of any desired size, including particles having an average size above 1 micrometer, between 100 nanometers and 1 micrometer, and below 100 nanometers. Silica can include nanosilica and amorphous fumed silica, for example. The fibers may be glass or ceramic fibers. Such fibers may have, for example, diameters in a range from 2 micrometers to 50 micrometers, in some embodiments 5 micrometers to 25 micrometers and lengths of at least about 500 micrometers. In some embodiments, each of the fillers in the composition according to the present disclosure has a mean particle size up to 100 micrometers as described in U.S. Pat. No. 8,034,852 (Janssen et al.).

Hollow ceramic elements can include hollow spheres and spheroids. Examples of commercially available materials suitable for use as the hollow, ceramic elements include glass bubbles marketed by 3M Company, Saint Paul, Minn., as “3M GLASS BUBBLES” in grades K1, K15, K₂O, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”; glass bubbles marketed by Potters Industries, Carlstadt, N.J., under the trade designations “Q-CEL HOLLOW SPHERES” (e.g., grades 30, 6014, 6019, 6028, 6036, 6042, 6048, 5019, 5023, and 5028); and hollow glass particles marketed by Silbrico Corp., Hodgkins, Ill. under the trade designation “SIL-CELL” (e.g., grades SIL 35/34, SIL-32, SIL-42, and SIL-43). The hollow, ceramic elements may also be made from ceramics such as alpha-alumina, zirconia, and alumina silicates. In some embodiments, the hollow, ceramic elements are aluminosilicate microspheres extracted from pulverized fuel ash collected from coal-fired power stations (i.e., cenospheres). Useful cenospheres include those marketed by Sphere One, Inc., Chattanooga, Tenn., under the trade designation “EXTENDOSPHERES HOLLOW SPHERES” (e.g., grades SG, MG, CG, TG, HA, SLG, SL-150, 300/600, 350 and FM-1). Other useful hollow, ceramic spheroids include silica-alumina ceramic hollow spheres with thick walls marketed by Valentine Chemicals of Lockport, La., as ZEEOSPHERES CERAMIC MICROSPHERES in grades N-200, N-200PC, N-400, N-600, N-800, N1000, and N1200. The hollow ceramic elements may have one of a variety of useful sizes but typically has a maximum dimension, or average diameter, of less than 10 millimeters (mm), more typically less than one mm. In some embodiments, the hollow ceramic elements have a maximum dimension in a range from 0.1 micrometer to one mm, from one micrometer to 500 micrometers, from one micrometer to 300 micrometers, or even from one micrometer to 100 micrometers. The mean particle size of the hollow, ceramic elements may be, for example, in a range from 5 to 250 micrometers (in some embodiments from 10 to 110 micrometers, from 10 to 70 micrometers, or even from 20 to 40 micrometers). As used herein, the term size is considered to be equivalent with the diameter and height, for example, of glass bubbles.

The composition according to the present disclosure and/or useful for practicing the present disclosure can include an adhesion promoter comprising at least one acid group and at least one carbon-carbon double bond or carbon-carbon triple bond. The adhesion promoter can be useful, for example, for improving adhesion to metal surfaces. The adhesion promoter can be an unsaturated carboxylic acid having at least six carbon atoms. The adhesion promoter can be an unsaturated fatty acid having up to 24 carbon atoms. The unsaturated carboxylic acid can have a range of 6 to 24, 8 to 22, or 8 to 20 carbon atoms and one, two, or three double bonds. In some embodiments, at least one of the carbon-carbon double bonds in the unsaturated carboxylic acid is a terminal double bond. In some embodiments, the adhesion promoter is 10-undecenoic acid. In some embodiments, the adhesion promoter is acrylic acid, maleic acid, methacrylic acid, monoalkyl esters of maleic acid, fumaric acid, monoalkyl esters of fumaric acid, itaconic acid, isocrotonic acid, crotonic acid, citraconic acid, and beta-carboxyethyl acrylate. In some embodiments, the adhesion promoter is acrylic acid, itaconic acid, or beta-carboxyethyl acrylate. In some embodiments, the adhesion promoter is 10-undeeanoic acid, acrylic acid, itaconic acid, or beta-carboxyethyl acrylate. In some embodiments, the adhesion promoter is 10-undeeanoic acid or acrylic acid. Other compounds that may be useful as adhesion promoters having at least one carbon-carbon double bond or carbon-carbon triple bond are those available, for example, from Sartomer USA under the trade designation “SR9050” and from Rhodia, Inc., La Defense, France, under the trade designation “SIPOMER PAM-200”. In some embodiments, the adhesion promoter is present in an amount in a range from 0.05 weight percent to about 10 weight percent (in some embodiments, 0.1 weight percent to 5 weight percent, or 0.5 weight percent to 2 weight percent), based on the total weight of the composition.

The composition according to the present disclosure and/or useful for practicing the present disclosure can include one or more radical inhibitors. Radical inhibitors can be useful, for example, for improving the shelf life of the composition. Examples of useful classes of radical inhibitors include phenolic compounds, stable radicals like galvinoxyl and N-oxyl based compounds, catechols, triaryl phosphites, triaryl phosphines, phosphonic acids, and phenothiazines. Examples of useful radical inhibitors that can be used in composition according to the present disclosure include 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, naphthoquinone, pyrogallol, 1-oxyl-2,2,6,6-tetramethylpiperidine, 1-oxyl-2,2,6,6-tetramethylpiperidine-4-ol, 1-oxyl-2,2,6,6-tetramethylpiperidine-4-one, 1-oxyl-2,2,6,6-tetramethyl-4-carboxyl-piperidine, 1-oxyl-2,2,5,5-tetramethylpyrrolidine, 1-oxyl-2,2,5,5-tetramethyl-3-carboxypyrrolidine, aluminium-N-nitrosophenyl hydroxylamine, diethylhydroxylamine, phenylphosphonic acid, triphenyl phosphite, phenothiazine and/or derivatives or combinations of any of these compounds. Any useful amount of radical inhibitor may be included in the composition disclosed herein. In some embodiments, the amount of radical inhibitor in the composition according to the present disclosure is in the range of from 0.0001% to 10% (in some embodiments, 0.001% to 1% or 0.05% to 0.1%) by weight, based on the total weight of resin and other reactive components.

The composition according to the present disclosure and/or useful for practicing the present disclosure can include at least one monofunctional reactive diluent. Monofunctional reactive diluents typically have one functional group that can undergo polymerization. Monofunctional reactive diluents may be useful, for example, for at least one of modifying the viscosity of the composition or altering the rate of curing, for example, to increase the time the composition remains spreadable. Monofunctional reactive diluents include vinyl acetate, allyl acetate, allyl ethyl ether, pentaerythritol allyl ether, trimethylolpropane allyl ether, and 3-allyloxy-1,2-propanediol. Reactive diluents also include vinyl ethers such as ethyl vinyl ether, n-propyl vinyl ether, iso-propyl vinyl ether, n-butyl vinyl ether, iso-butyl vinyl ether, cyclohexyl vinyl ether, hydroxybutyl vinyl ether, 2-ethylhexyl vinyl ether, dodecyl vinyl ether, and octadecyl vinyl ether. The composition of the present disclosure can have at least 0.1, 0.25, 0.5, or at least 1 percent by weight of any of these reactive diluents or combination thereof. The composition according to the present disclosure and/or useful for practicing the present disclosure can include up to 10, 5, 4, 3, 2, 1 percent by weight of any of these reactive diluents. In some embodiments, the composition according to the present disclosure and/or useful for practicing the present disclosure can include up to 5, 4, 3, 2, 1, 0.5, 0.25, or 0.1 percent by weight of any vinyl ether or can be free of vinyl ethers. These percentages are based on the total weight of the composition.

Reactive diluents can also include acrylate and methacrylates such as methyl (meth)acrylate, ethyl (meth)acrylate, isopropyl (meth)acrylate, n-butyl (meth)acrylate, isobutyl (meth)acrylate, 2-ethylhexyl (meth)acrylate, lauryl (meth)acrylate, ethylene glycol dicyclopentenyl ether (meth)acrylate, and propanediol dicyclopentenyl ether (meth)acrylate. Hydroxy-functionalized (meth)acrylates that can be used as reactive diluents include hydroxyethyl methacrylate, hydroxypropyl methacrylate, hydroxyethyl acrylate, and hydroxypropyl acrylate. The composition of the present disclosure can have at least 0.1, 0.25, 0.5, or at least 1 percent by weight of any of these reactive diluents or combination thereof. However, since the presence of an acrylate or methacrylate can change the kinetics of the reaction, it may be beneficial to choose a reactive diluent other than an acrylate or methacrylate. In some embodiments, the composition according to the present disclosure and/or useful for practicing the present disclosure can include up to 5, 4, 3, 2, 1, 0.5, 0.25, or 0.1 percent by weight of any acrylate or methacrylate or can be free of acrylates and methacrylates. These percentages are based on the total weight of the composition.

Other common reactive diluents include vinyl aromatic compounds having at least one vinyl substituent on an aromatic ring, typically a benzene ring or a naphthalene ring. In addition to the vinyl substituent, the vinyl aromatic compound may also include other substituents (e.g., alkyl, alkoxy, or halogen). Examples of such vinyl aromatic compounds include styrene, alpha-methyl styrene, p-methyl styrene, p-tert-butyl styrene, chlorostyrene, dichlorostyrene, p-ethoxystyrene, p-propoxystyrene, divinyl benzene, and vinyl naphthalene. In some embodiments, the composition of the present disclosure or useful for practicing the present disclosure can up to five percent by weight of a vinyl aromatic reactive diluent. The composition according to the present disclosure and/or useful for practicing the present disclosure can include up to 4, 3, 2, 1, 0.5, 0.25, or 0.1 percent by weight of a vinyl aromatic reactive diluent. These percentages are based on the total weight of the composition. However, in some cases it may be useful to avoid vinyl aromatic reactive diluents because of the environmental concerns described above. The composition according to the present disclosure and/or useful for practicing the present disclosure can be free of vinyl aromatic reactive diluents. In particular, the composition according to the present disclosure and/or useful for practicing the present disclosure can be free of styrene.

The reactive diluents described above typically have flash points up to 150° C. In some cases, these reactive diluents have flash points up to 125° C., 100° C., or 80° C. The composition according to the present disclosure and/or useful for practicing the present disclosure can include up to 5, 4, 3, 2, 1, 0.5, 0.25, or 0.1 percent by weight of any of these reactive diluents or can be free of any of these reactive diluents. The composition according to the present disclosure and/or useful for practicing the present disclosure can include up to five percent by weight of a reactive diluent having a flash point up to 150° C. The composition according to the present disclosure and/or useful for practicing the present disclosure can include up to 4, 3, 2, 1, 0.5, 0.25, or 0.1 percent by weight of a reactive diluent having a flash point up to 150° C. In some cases, the composition according to the present disclosure and/or useful for practicing the present disclosure can be free of reactive diluent having a flash point up to 150° C.

The composition according to the present disclosure and/or useful for practicing the present disclosure can include up to 15 percent by weight of volatile organic compounds (VOCs). A VOC generally has at least one of a vapor pressure greater than 0.1 mm Hg at 20° C. or a boiling point of less than 216° C. In some embodiments, a VOC has a vapor pressure greater than 0.05 mm Hg at 20° C. or 0.02 mm Hg at 20° C. In some embodiments, a VOC has a boiling point of less than 200° C. or less than 185° C. VOCs can include the reactive diluents described above and solvents such as those not listed as “exempt” or otherwise excluded in the California Consumer Products Regulations, Subchapter 8.5, Article 2, 94508, last amended Sep. 17, 2014 (Register 2014, No. 38). Such solvents, which are not exempt, include hydrocarbon solvents (e.g., benzene, toluene, xylenes, and d-limonene); acyclic and cyclic ketones (e.g., pentanone, hexanone, cyclopentanone, and cyclohexanone); acyclic or cyclic acetals, ketals or ortho esters (e.g., diethoxy methane, dimethoxy methane, dipropoxy methane, dimethoxy ethane, diethoxy ethane, dipropoxy ethane, 2,2-dimethoxy propane, 2,2-diethoxy propane, 2,2-dipropoxy propane, 2,2-dimethyl-1,3-dioxalane, trimethyl orthoformate, triethyl orthoformate, trimethyl orthoacetate, triethyl orthoacetate, trimethyl orthobenzoate, and triethyl orthobenzoate); and alcoholic solvents (e.g., methanol, ethanol, or propanol such as isopropanol). A person skilled in the art can readily determine which solvents have exempt or excluded status in the California Consumer Products Regulations. In some cases, VOCs have flash points up to 100° C. or 80° C. The composition according to the present disclosure and/or useful for practicing the present disclosure can include up to 14, 13, 12, 10, 9, 8, 7, 6, 5, 4, 3, 2, 1, 0.5, 0.25, or 0.1 percent by weight of any of these VOCs or can be free of any of these VOCs. These percentages are based on the total weight of the composition.

As shown in the Examples, below, the presence of a tertiary amine can slow down the curing of the composition of the present disclosure, as evidenced by the time to achieve a tack-free surface (see Illustrative Example 10). Accordingly, in some embodiments, the composition according to and/or useful for practicing the present disclosure is substantially free of a tertiary amine. Such tertiary amines include N,N-dialkyl toluidines, where each alkyl group is optionally substituted by hydroxyl and independently selected from among methyl, ethyl, hydroxyethyl, hydroxylpropyl, isopropyl and mixtures thereof); trialkyl amines, where each alkyl is optionally substituted by hydroxyl and independently selected from among ethyl, propyl, and hydroxyethyl; N,N-dialkylanilines (e.g., N,N-dimethylaniline and N,N-diethylaniline); and 4,4-bis(dimethylamino) diphenylmethane. “Substantially free of a tertiary amine” refers to an amount less than 0.5, 0.1, or less than 0.05 percent by weight, based on the total weight of the composition. “Substantially free of a tertiary amine” can also refer to being free of tertiary amine.

In some embodiments, the composition according to and/or useful for practicing the present disclosure is substantially free of a nitrogen-containing base in general. Such nitrogen containing bases can included guanidines such as diphenylguanidine and substituted or unsubstituted nitrogen containing rings. “Substantially free of a nitrogen-containing base” refers to an amount less than 0.5, 0.1, or less than 0.05 percent by weight, based on the total weight of the composition. “Substantially free of a nitrogen-containing base” can also refer to being free of a nitrogen-containing base.

Compositions according to the present disclosure can be packaged, for example, as a two-part composition (e.g., body repair composition), wherein a first part comprises the composition including any of the components described above, and a second part comprises a free-radical initiator (e.g., organic peroxide or organic hydroperoxide). The volumetric ratio of the first to second part may be in the range of, e.g., 10:1 or higher, 20:1 or higher, or 25:1 or higher, or 30:1 or higher.

Examples of useful organic peroxides and hydroperoxides include hydroperoxides (e.g., cumene, tert-butyl or tert-amyl hydroperoxide), dialkyl peroxides (e.g., di-tert-butylperoxide, dicumylperoxide, or cyclohexyl peroxide), peroxyesters (e.g., tert-butyl peroxybenzoate, tert-butyl peroxy-2-ethylhexanoate, tert-butyl peroxy-3,5,5-trimethylhexanoate, tert-butyl monoperoxymaleate, or di-tert-butyl peroxyphthalate), and diacylperoxides (e.g., benzoyl peroxide or lauryl peroxide). Other examples of useful organic peroxides include peroxycarbonates (e.g., tert-butylperoxy 2-ethylhexylcarbonate, tert-butylperoxy isopropyl carbonate, or di(4-tert-butylcyclohexyl) peroxydicarbonate) and ketone peroxides (e.g., methyl ethyl ketone peroxide, 1,1-di(tert-butylperoxy)cyclohexane, 1,1-di(tert-butylperoxy)-3,3,5-trimethylcyclohexane, and cyclohexanone peroxide). The organic peroxide may be selected, for example, based on the temperature desired for use of the organic peroxide and compatibility with the polymeric resin desired to be cured. For curing at room temperature, benzoyl peroxide, cumene hydroperoxide, cyclohexanone peroxide, diisopropylbenzene dihydroperoxide, t-butyl monoperoxymaleate, lauryl peroxide, methyl ethyl ketone peroxide, t-butyl hydroperoxide, tert-butyl peroxybenzoate, or mixtures thereof may be useful. Organic hydroperoxides and/or hydroperoxides can be added in any amount suitable to initiate curing. In some embodiments, at least one of a peroxide or hydroperoxide is combined with the composition in an amount up to 10, 5, 4, 3, 2.5, or 2 percent by weight, based on the total weight of the composition.

For convenience, when adding organic peroxides and hydroperoxides to a composition according to the present disclosure, the peroxide may be used in a formulation (e.g., paste) that also includes a diluent. The diluent can be a plasticizer, mineral spirits, water, or solvent (e.g., N-methyl-2-pyrrolidone, tetrahydrofuran, or ethyl acetate). For example, pastes made from benzoyl peroxide, ketone peroxides (e.g., methyl ethyl ketone peroxide), hydroperoxides (e.g., cumene hydroperoxide), peroxyesters (e.g., t-butyl peroxy-2-ethylhexanoate), and diperoxyketals are all sold commercially. The organic hydroperoxide and its amount may be selected to provide the composition with a desirable amount of time that it can be spread on a surface after it is mixed and a desirable amount of time before it can be sanded after it is cured.

The present disclosure provides a method of repairing a damaged surface. The method includes combining the composition described above in any of its embodiments with an organic peroxide or hydroperoxide, applying the composition comprising the organic peroxide or hydroperoxide to the damaged surface, and curing the composition on the damaged surface. In some embodiments, the damaged surface comprises an irregularly shaped dent or cavity. Typically, the damage represents a change from the original surface contour and results from an accident or other unintentional use.

The present disclosure provides a cured composition made from the curable composition according to any of the above embodiments as well as an article comprising the cured composition on a surface.

One application of compositions according to the present disclosure are curable body repair materials useful in the repair of damaged vehicles and other equipment (e.g., cars, trucks, watercraft, windmill blades, aircraft, recreational vehicles, bathtubs, storage containers, and pipelines). Curable body repair materials can include two reactive components (e.g., a curable polymeric resin and catalyst or initiator) which are mixed together to form the curable body repair material.

In some embodiments of the method of the present disclosure, the damaged surface to be repaired is on at least a portion of a vehicle (e.g., automobile, truck, or other land vehicle). Similarly, in some embodiments of the article of the present disclosure, the article is a portion of a vehicle. In some embodiments, the damaged surface comprises iron (e.g., steel, galvanized steel, high-strength steel, cold rolled steel, and e-coated steel). In some embodiments, the damaged surface comprises no greater than 50, 40, 30, or 20 percent aluminum, and, in some embodiments, the damaged surface is other than an aluminum surface.

The process of repairing dents and other damage using body repair materials can present challenges. For repairing an automobile, for example, a technician typically mixes the two reactive components and then uses a squeegee to spread the repair compound onto the surface of the vehicle to roughly match the contour of the surface. As the curable polymeric resin reacts with the curative or initiator, it hardens to a state where it can be shaped to match the contour of the vehicle before it was damaged. During this hardening process, the repair compound typically transitions from a state of soft, gelled material to a state of moderately hard material that is relatively easy to shape with an abrasive article (e.g., sandpaper) to a state of hard material. Body repair materials typically require handling in a relatively narrow time window. Premature sanding of body repair material before it has reached a critical amount of cure results in sandpaper becoming plugged reducing its effectiveness, the surface of the body repair material becoming rough, and sometimes the body repair material peeling away from the surface of the vehicle. If this situation occurs, then typically the body repair material has to be partially removed (usually by sanding) such that another layer of body repair material can be put on top and properly shaped. Furthermore, it is challenging for body repair materials to adhere well to a variety of common repair surfaces (e.g., aluminum, galvanized steel, E-coats, primers, and paints).

The composition according to the present disclosure has multiple advantages as a body repair composition. Typically and advantageously, in many embodiments, the composition according to present disclosure is spreadable for at least four minutes. Typically and advantageously, in many embodiments, the composition according to present disclosure hardens within 20 or 25 minutes of being applied to a surface and cannot be readily scratched off the surface.

Since the compositions according to the present disclosure can be cured at room temperature, it is typically not necessary to apply additional heat or light to cure the composition, eliminating the need for specialized equipment for elevating the temperature or light-curing the composition. The compositions of the present disclosure can therefore be free of photoinitiator. Examples of photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); 1-hydroxycyclohexyl phenyl ketone; and acylphosphine oxide derivatives and acylphosphonate derivatives (e.g., bis(2,4,6-trimethylbenzoyl)phenylphosphine oxide, diphenyl-2,4,6-trimethylbenzoylphosphine oxide, isopropoxyphenyl-2,4,6-trimethylbenzoylphosphine oxide, or dimethyl pivaloylphosphonate). Different photoinitiators require different wavelengths for curing. In some embodiments, the composition of the present disclosure is free of a visible-light-curing photointiator (e.g., acylphosphine oxide derivatives such as bis(2,4,6-trimethylbenzoyl)phenylphosphine oxide, diphenyl-2,4,6-trimethylbenzoylphosphine oxide, or isopropoxyphenyl-2,4,6-trimethylbenzoylphosphine oxide). In some embodiments, a photoinitiator is included the composition in an amount up to 3, 2.5, 2, or 1 percent by weight, based on the total weight of the composition.

### Some Embodiments of the Disclosure

In a first embodiment, the present disclosure provides a composition comprising:

a polythiol comprising more than one or more than two thiol groups; and

an allylic resin comprising more than one or more than two allyl groups.

In a second embodiment, the present disclosure provides the composition of the first embodiment, further comprising inorganic filler.

In a third embodiment, the present disclosure provides the composition of the second embodiment, wherein the inorganic filler comprises at least one of ceramic beads, silica, hollow ceramic elements, alumina, zirconia, mica, dolomite, wollastonite, fibers, talc, calcium carbonate, or clay.

In a fourth embodiment, the present disclosure provides the composition of any one of the first to third embodiments, wherein the polythiol has a molecular weight of up to 500 grams per mole.

In a fifth embodiment, the present disclosure provides the composition of any one of the first to third embodiments, wherein the polythiol has a number average molecular weight of more than 500 grams per mole or at least 1000 grams per mole.

In a sixth embodiment, the present disclosure provides the composition of the fifth embodiment, wherein the polythiol is a polythioether oligomer or polymer or a polysulfide oligomer or polymer.

The polythioether oligomer or polymer can be prepared from components comprising a dithiol and a diene or divinyl ether and optionally a trithiol, triene, or trivinyl ether.

In a seventh embodiment, the present disclosure provides the composition of any one of the first to sixth embodiments, wherein the polythiol comprises ester groups.

In an eighth embodiment, the present disclosure provides the composition of any one of the first to seventh embodiments, wherein the allylic resin is an allylic functional aliphatic oligomer, an allylic functional polyurethane, an allylic functional polyester, an allylic functional polyether, an allylic functional polythioether, or a diallyl phthalate resin.

In a ninth embodiment, the present disclosure provides the composition of any one of the first to eighth embodiments, wherein the allylic resin is an allylic functional polyurethane, an allylic functional polyester, an allylic functional polyether, or a diallyl phthalate resin.

In a tenth embodiment, the present disclosure provides the composition of any one of the first to ninth embodiments, wherein the allylic resin is substantially free of sulfur atoms and/or hydroxyl groups.

In an eleventh embodiment, the present disclosure provides the composition of any one of the first to tenth embodiments, further comprising an unsaturated compound having more than one carbon-carbon double bond, more than one carbon-carbon triple bond, or combination thereof.

In a twelfth embodiment, the present disclosure provides the composition of the eleventh embodiment, wherein the unsaturated compound comprising more than one carbon-carbon double bond, carbon-carbon triple bond, or a combination thereof comprises at least one of a diene, a diyne, a divinyl ether, a diallyl ether, or an ene-yne.

In a thirteenth embodiment, the present disclosure provides the composition of any one of the first to twelfth embodiments, further comprising an adhesion promoter comprising at least one acid group and at least one carbon-carbon double bond or carbon-carbon triple bond.

In a fourteenth embodiment, the present disclosure provides the composition of the thirteenth embodiment, wherein the adhesion promoter comprises at least one of a carboxylic acid having at least six carbon atoms and one, two, or three double bonds, acrylic acid, itaconic acid, or beta-carboxyethyl acrylate.

In a fifteenth embodiment, the present disclosure provides the composition of the fourteenth embodiment, wherein the adhesion promoter comprises 10-undecenoic acid.

In a sixteenth embodiment, the present disclosure provides the composition of any one of the first to fifteenth embodiments, further comprising a monofunctional reactive diluent.

In a seventeenth embodiment, the present disclosure provides the composition of the sixteenth embodiment, wherein the monofunctional reactive diluent comprises vinyl acetate.

In an eighteenth embodiment, the present disclosure provides the composition of any one of the first to the seventeenth embodiments, further comprising a radical inhibitor.

In a nineteenth embodiment, the present disclosure provides the composition of the eighteenth embodiment, wherein radical inhibitor comprises triphenylphosphite.

In a twentieth embodiment, the present disclosure provides the composition of any one of the first to nineteenth embodiments, wherein the composition is substantially free of styrene.

In a twenty-first embodiment, the present disclosure provides the composition of any one of the first to twentieth embodiments, wherein the composition is substantially free of photoinitiator.

In a twenty-second embodiment, the present disclosure provides the composition of any one of the first to twenty-first embodiments, wherein a number of the thiol groups is within 20 percent of a number of the allyl groups.

In a twenty-third embodiment, the present disclosure provides the composition of any one of the first to twenty-second embodiments, further comprising an organic peroxide or organic hydroperoxide.

In a twenty-fourth embodiment, the present disclosure provides the composition of the twenty-third embodiment, wherein the organic peroxide or organic hydroperoxide comprises at least one of benzoyl peroxide, cumene hydroperoxide, cyclohexanone peroxide, diisopropylbenzene dihydroperoxide, t-butyl monoperoxymaleate, lauryl peroxide, methyl ethyl ketone peroxide, tert-butyl hydroperoxide, or tert-butyl peroxybenzoate.

In a twenty-fifth embodiment, the present disclosure provides the composition of the twenty-fourth embodiment, wherein the organic peroxide or organic hydroperoxide comprises tert-butyl peroxybenzoate.

In a twenty-sixth embodiment, the present disclosure provides the composition of any one of the first to twenty-second embodiments packaged as a two-part body repair composition, wherein a first part comprises the composition and a second part comprises an organic peroxide or organic hydroperoxide.

In a twenty-seventh embodiment, the present disclosure provides the composition of the twenty-sixth embodiment, wherein the organic peroxide or organic hydroperoxide comprises at least one of benzoyl peroxide, cumene hydroperoxide, cyclohexanone peroxide, diisopropylbenzene dihydroperoxide, t-butyl monoperoxymaleate, lauryl peroxide, methyl ethyl ketone peroxide, tert-butyl hydroperoxide, or tert-butyl peroxybenzoate.

In a twenty-eighth embodiment, the present disclosure provides the composition of the twenty-seventh embodiment, wherein the organic peroxide or organic hydroperoxide comprises tert-butyl peroxybenzoate.

In a twenty-ninth embodiment, the present disclosure provides an article prepared from the composition of any one of the twenty-sixth to twenty-eighth embodiments by combining the first part and the second part and curing the composition.

In a thirtieth embodiment, the present disclosure provides use of the composition of any one of the first to twenty-fifth embodiments as a body repair composition.

In a thirty-first embodiment, the present disclosure provides a method of repairing a damaged surface, the method comprising:

combining the composition of any one of the first to twenty-second embodiments with at least one of an organic peroxide or an organic hydroperoxide;

applying the composition comprising at least one of the organic peroxide or the organic hydroperoxide to the damaged surface; and

curing the composition on the damaged surface to provide a cured composition.

In a thirty-second embodiment, the present disclosure provides the method of the thirty-first composition, wherein the damaged surface is on at least a portion of a vehicle.

In a thirty-third embodiment, the present disclosure provides the method of the thirty-first or thirty-second embodiment, wherein curing is carried out at room temperature.

In a thirty-fourth embodiment, the present disclosure provides the method of any one of the thirty-first to thirty-third embodiments, further comprising sanding the cured composition.

In a thirty-fifth embodiment, the present disclosure provides use of a composition comprising a polythiol comprising more than one or more than two thiol groups, an allylic compound comprising more than one or more than two allyl groups, and inorganic filler as body repair composition, wherein a number of the thiol groups is within 20 percent of a number of the allyl groups.

In a thirty-sixth embodiment, the present disclosure provides the use of the thirty-fifth embodiment, wherein the inorganic filler comprises at least one of ceramic beads, silica, hollow ceramic elements, alumina, zirconia, mica, dolomite, wollastonite, fibers, talc, calcium carbonate, or clay.

In a thirty-seventh embodiment, the present disclosure provides the use of the thirty-fifth or thirty-sixth embodiments, wherein the polythiol has a molecular weight of up to 500 grams per mole.

In a thirty-eighth embodiment, the present disclosure provides the use of any one of the thirty-fifth to thirty-seventh embodiments, wherein the polythiol has a number average molecular weight of more than 500 grams per mole or at least 1000 grams per mole.

In a thirty-ninth embodiment, the present disclosure provides the use of the thirty-eighth embodiment, wherein the polythiol is a polythioether oligomer or polymer or a polysulfide oligomer or polymer.

The polythioether oligomer or polymer can be prepared from components comprising a dithiol and a diene or divinyl ether and optionally a trithiol, triene, or trivinyl ether.

In a fortieth embodiment, the present disclosure provides the use of any one of the thirty-fifth to thirty-ninth embodiments, wherein the polythiol comprises ester groups, and/or wherein the allylic compound is substantially free of sulfur atoms, and/or wherein the allylic compound is substantially free of hydroxyl groups.

In a forty-first embodiment, the present disclosure provides the use of any one of the thirty-fifth to fortieth embodiments, wherein the allylic compound is a diallyl ether, a triallyl ether, or a tetraallyl ether.

In a forty-second embodiment, the present disclosure provides the use of any one of the thirty-fifth to forty-first embodiments, wherein the composition further comprises at least one of a diene, a diyne, a divinyl ether, or an ene-yne.

In a forty-third embodiment, the present disclosure provides the use of any one of the thirty-fifth to forty-second embodiments, wherein the composition further comprises an adhesion promoter comprising at least one acid group and at least one carbon-carbon double bond or carbon-carbon triple bond.

In a forty-fourth embodiment, the present disclosure provides the use of the forty-third embodiment, wherein the adhesion promoter comprises at least one of a carboxylic acid having at least six carbon atoms and one, two, or three double bonds, acrylic acid, itaconic acid, or beta-carboxyethyl acrylate.

In a forty-fifth embodiment, the present disclosure provides the use of the forty-fourth embodiment, wherein the adhesion promoter comprises 10-undecenoic acid.

In a forty-sixth embodiment, the present disclosure provides the use of any one of the thirty-fifth to forty-fifth embodiments, wherein the composition further comprises a monofunctional reactive diluent.

In a forty-seventh embodiment, the present disclosure provides the use of the forty-sixth embodiment, wherein the monofunctional reactive diluent comprises vinyl acetate.

In a forty-eighth embodiment, the present disclosure provides the use of any one of the thirty-fifth to the forty-seventh embodiments, wherein the composition further comprises a radical inhibitor.

In a forty-ninth embodiment, the present disclosure provides the use of the forty-eighth embodiment, wherein radical inhibitor comprises triphenylphosphite.

In a fiftieth embodiment, the present disclosure provides the use of any one of the thirty-fifth to forty-ninth embodiments, wherein the composition is substantially free of styrene.

In a fifty-first embodiment, the present disclosure provides the use of any one of the thirty-fifth to fiftieth embodiments, wherein the composition is substantially free of photoinitiator.

In a fifty-second embodiment, the present disclosure provides the use of any one of the thirty-fifth to fifty-first embodiments, wherein the composition further comprises an organic peroxide or organic hydroperoxide.

In a fifty-third embodiment, the present disclosure provides the use of the fifty-second embodiment, wherein the organic peroxide or organic hydroperoxide comprises at least one of benzoyl peroxide, cumene hydroperoxide, cyclohexanone peroxide, diisopropylbenzene dihydroperoxide, t-butyl monoperoxymaleate, lauryl peroxide, methyl ethyl ketone peroxide, tert-butyl hydroperoxide, or tert-butyl peroxybenzoate.

In a fifty-fourth embodiment, the present disclosure provides the use of the fifty-third embodiment, wherein the organic peroxide or organic hydroperoxide comprises tert-butyl peroxybenzoate.

In a fifty-fifth embodiment, the present disclosure provides the use of any one of the thirty-fifth to fifty-fourth embodiments, wherein the composition is packaged as a two-part body repair composition, wherein a first part comprises the composition and a second part comprises an organic peroxide or organic hydroperoxide.

In a fifty-sixth embodiment, the present disclosure provides the use of the fifty-fifth embodiment, wherein the organic peroxide or organic hydroperoxide comprises at least one of benzoyl peroxide, cumene hydroperoxide, cyclohexanone peroxide, diisopropylbenzene dihydroperoxide, t-butyl monoperoxymaleate, lauryl peroxide, methyl ethyl ketone peroxide, tert-butyl hydroperoxide, or tert-butyl peroxybenzoate.

In a fifty-seventh embodiment, the present disclosure provides the use of the fifty-sixth embodiment, wherein the organic peroxide or organic hydroperoxide comprises tert-butyl peroxybenzoate.

In a fifty-eighth embodiment, the present disclosure provides a method of repairing a damaged surface, the method comprising:

combining a composition comprising a polythiol comprising more than one or more than two thiol groups, an allylic compound comprising more than one or more than two allyl groups, and inorganic filler with at least one of an organic peroxide or an organic hydroperoxide, wherein a number of the thiol groups is within 20 percent of a number of the allyl groups;

applying the composition comprising at least one of the organic peroxide or the organic hydroperoxide to the damaged surface; and

curing the composition on the damaged surface to provide a cured composition.

In a fifty-ninth embodiment, the present disclosure provides the method of the fifty-eighth composition, wherein the damaged surface is on at least a portion of a vehicle.

In a sixtieth embodiment, the present disclosure provides the method of the fifty-eighth or fifty-ninth embodiment, wherein curing is carried out at room temperature.

In a sixty-first embodiment, the present disclosure provides the method of any one of the fifty-eighth to sixtieth embodiments, further comprising sanding the cured composition.

In a sixty-second embodiment, the present disclosure provides the method of any one of the fifty-eighth to sixty-first embodiments, wherein the inorganic filler comprises at least one of ceramic beads, silica, hollow ceramic elements, alumina, zirconia, mica, dolomite, wollastonite, fibers, talc, calcium carbonate, or clay.

In a sixty-third embodiment, the present disclosure provides the method of any one of the fifty-eighth to sixty-second embodiments, wherein the polythiol has a molecular weight of up to 500 grams per mole.

In a sixty-fourth embodiment, the present disclosure provides the method of any one of the fifty-eighth to sixty-third embodiments, wherein the polythiol has a number average molecular weight of more than 500 grams per mole or at least 1000 grams per mole.

In a sixty-fifth embodiment, the present disclosure provides the method of any one of the fifty-eighth to sixty-fourth embodiments, wherein the polythiol is a polythioether oligomer or polymer or a polysulfide oligomer or polymer.

The polythioether oligomer or polymer can be prepared from components comprising a dithiol and a diene or divinyl ether and optionally a trithiol, triene, or trivinyl ether.

In a sixty-sixth embodiment, the present disclosure provides the method of any one of the fifty-eighth to sixty-fifth embodiments, wherein the polythiol comprises ester groups, and/or wherein the allylic compound is substantially free of sulfur atoms, and/or wherein the allylic compound is substantially free of hydroxy groups.

In a sixty-seventh embodiment, the present disclosure provides the method of any one of the fifty-eighth to sixty-sixth embodiments, wherein the allylic compound is a diallyl ether, a triallyl ether, or a tetraallyl ether.

In a sixty-eighth embodiment, the present disclosure provides the method of any one of the fifty-eighth to sixty-seventh embodiments, wherein the composition further comprises at least one of a diene, a diyne, a divinyl ether, or an ene-yne.

In a sixty-ninth embodiment, the present disclosure provides the method of any one of the fifty-eighth to sixty-eighth embodiments, wherein the composition further comprises an adhesion promoter comprising at least one acid group and at least one carbon-carbon double bond or carbon-carbon triple bond.

In a seventieth embodiment, the present disclosure provides the method of the sixty-ninth embodiment, wherein the adhesion promoter comprises at least one of a carboxylic acid having at least six carbon atoms and one, two, or three double bonds, acrylic acid, itaconic acid, or beta-carboxyethyl acrylate.

In a seventy-first embodiment, the present disclosure provides the method of the seventieth embodiment, wherein the adhesion promoter comprises 10-undecenoic acid.

In a seventy-second embodiment, the present disclosure provides the method of any one of the fifty-eighth to seventy-first embodiments, wherein the composition further comprises a monofunctional reactive diluent.

In a seventy-third embodiment, the present disclosure provides the method of the seventy-second embodiment, wherein the monofunctional reactive diluent comprises vinyl acetate.

In a seventy-fourth embodiment, the present disclosure provides the method of one of the fifty-eighth to the seventy-third embodiments, wherein the composition further comprises a radical inhibitor.

In a seventy-fifth embodiment, the present disclosure provides the method of the seventy-fourth embodiment, wherein radical inhibitor comprises triphenylphosphite.

In a seventy-sixth embodiment, the present disclosure provides the method of any one of the fifty-eighth to seventy-fifth embodiments, wherein the composition is substantially free of styrene.

In a seventy-seventh embodiment, the present disclosure provides the method of any one of the fifty-eighth to seventy-sixth embodiments, wherein the composition is substantially free of photoinitiator.

In a seventy-eighth embodiment, the present disclosure provides the method of any one of the fifty-eighth to seventy-seventh embodiments, wherein the organic peroxide or organic hydroperoxide comprises at least one of benzoyl peroxide, cumene hydroperoxide, cyclohexanone peroxide, diisopropylbenzene dihydroperoxide, t-butyl monoperoxymaleate, lauryl peroxide, methyl ethyl ketone peroxide, tert-butyl hydroperoxide, or tert-butyl peroxybenzoate.

In a seventy-ninth embodiment, the present disclosure provides the method of the seventy-eighth embodiment, wherein the organic peroxide or organic hydroperoxide comprises tert-butyl peroxybenzoate.

In an eightieth embodiment, the present disclosure provides a composition comprising:

a polythiol comprising more than two thiol groups;

an allylic resin comprising more than two allyl groups;

inorganic filler;

vinyl acetate;

an adhesion promoter comprising at least one acid group and at least one carbon-carbon double bond or carbon-carbon triple bond; and

a radical inhibitor,

wherein a number of the thiol groups is within 20 percent of a number of the allyl groups. The composition can be free of a phototinitiator.

In order that this disclosure can be more fully understood, the following examples are set forth. It should be understood that these examples are for illustrative purposes only and are not to be construed as limiting this disclosure in any manner.

### EXAMPLES

### Materials

| | |
|---|---|
| CN9101 | A 100% reactive, allylic functional aliphatic oligomer, available under the |
| | trade designation ″CN9101” from Sartomer Company, Exton, Pennsylvania. |
| CN9102 | A 100% reactive, allylic functional aliphatic oligomer, available under the |
| | trade designation ″CN9102” from Sartomer Company. |
| DAPH | Diallyl phthalate available from Sigma-Aldrich, St. Louis, Missouri. |
| PTMP | Pentaerythritol tetra(3-mercaptopropionate), available from Tokyo Chemical |
| | Industry Co. Ltd., Tokyo, Japan. |
| PB-B1000 | A polybutadiene homopolymer available under the trade designation “NISSO- |
| | PB” from Nippon Soda Co., Ltd., Tokyo, Japan. |
| HET | N,N-bis(2-hydroxyethyl-p-toluidine. available from Sigma-Aldrich. |
| Styrene | Styrene (99%), stabilized with 10-15 ppm 4-tert-butylcatechol, available from |
| | Alfa Aesar Chemicals, Tewksbury, Massachusetts. |
| VAc | Vinyl acetate, available from Alfa Aesar Chemicals. |
| AA | Acrylic Acid, available from Alfa Aesar Chemicals. |
| 10-UDA | 10-undecenoic acid (99%), available from Alfa Aesar Chemicals. |
| ET3N | Triethylamine, available from EMD Millipore Corporation, Darmstadt, |
| | Germany. |
| BPO | A blue dyed, 50 wt. % benzoyl peroxide paste, available from Raichem, s.r.l., |
| | Reggio Emilia, Italy |
| TBPB | Tert-butyl peroxybenzoate (98%), available from Alfa Aesar Chemicals. |
| TIXOGEL VP | A clay, available under the trade designation “TIXOGEL VP” from Southern |
| | Clay Products, Inc., Louisville, Kentucky. |
| Mistron Monomix | A talc, available under the trade designation “Mistron Monomix” from |
| | Luzenac America, Centennial, Colorado |
| Marble White | Calcium carbonate, available under the trade designation “#10 White” from |
| | IMERYS, Roswell, Georgia. |
| Halox Zinc | Zinc phosphate, available under the trade designation “HALOX ZINC |
| Phosphate | PHOSPHATE” from Halox, Hammond, Indiana. |
| AB TALC | A talc, available under the trade designation “GRADE AB” from Luzenac |
| | America, Inc., Centennial, Colorado. |
| TiO₂ KRONOS | Titanium dioxide, available under the trade designation “KRONOS 2310” |
| | from Kronos Worldwide, Inc., Dallas, Texas. |
| Q-CELL DBQ | Glass hollow microspheres, available under the trade designation “Q-Cel |
| | 6717” from Potters Industries, Inc., Valley Forge, Pennsylvania. |

### Gel Time, Curing Time and Tackiness Test Methods

After the radical initiator was added to other components of a composition on the paper mixing board, per the “Example (Ex.) and Comparative Example (CE) Preparation” procedure described below, the plastic spreader was used to continue mixing. The Gel Time and Time to Achieve Curing into a Completely Solidified Coating start at the time of addition of radical initiator to the other components of the composition on the paper mixing board. After the initiator was completely mixed into the composition with the plastic spreader, the curing was observed. The Gel Time is defined as the time between the initial additions of the initiator until the time that the coating begins to become stringy or gel-like but is not yet fully cured. The Time to Achieve Curing into a Completely Solidified Coating is defined as the time between the initial additions of the initiator until the time that the coating solidifies, as determined by the lack of indentation in the coating surface when depressed with a fingernail. Surface tackiness was determined by touching the surface and feeling for the presence of stickiness.

### Preparation of Powder 1

Powder 1 was prepared by adding the components shown in Table 1 to a 1-L plastic jar and then mixing overnight using a Tube Roller Shaker, model UX-04750-22, available form Cole-Panner, Vernon Hills, Ill.

TABLE 1
Composition of Powder 1 (values in grams)

| Component | Amount (grams) |
|---|---|
| TIXOGEL VP | 38.20 |
| Mistron Monomix | 338.64 |
| Marble White | 98.94 |
| Halox Zinc Phosphate | 60.44 |
| AB TALC | 34.65 |
| TiO₂ KRONOS | 188.25 |
| Q-CELL DBQ | 234.0 |

### Example (Ex.) and Comparative Example (CE) Preparation

Examples and Comparative Examples were prepared using the following general procedure:
1. To a small glass container, added alkylene containing component (CN9101, CN9102, DAPB or PB-B1000) using a pipette.
2. Added PTMP using a pipette.
3. Alternated between heating the container with a heat gun (10-20 second intervals to prevent overheating) and mixing formulation in a “SPEEDMIXER” mixing machine (available from FlackTek, Inc., Landrum, S.C.) for 1-2 minutes. Continued until homogeneous solution formed.
4. Added other designated component(s) (HET, Styrene, VAc, AA, 10-UNA or ET3N) and then thoroughly mixed the solution on the “SPEEDMIXER” mixing machine.
5. Added Powder 1 using a large metal scoopula.
6. Mixed Powder 1 into solution using a small metal spatula for 1-2 minutes.
7. Pre-spread the mixture onto a disposable paper mixing board for a few seconds.
8. Added initiator (BPO or TBPB) by placing the liquid on a rectangular plastic spreader and then combined the liquid onto the mixture. Thoroughly mixed the initiator into the mixture for 1-2 minutes, and then allowed the mixture to sit on the paper and harden.

The specific compositions of the Examples (Ex. 1, Ex. 2, Ex. 5 through Ex. 9 and Ex. 11 through Ex. 13 and Illustrative Examples (IE-3, IE-4, and IE-10) are shown in Table 2 and Table 3.

TABLE 2
Composition of Various Examples and Comparative Examples (values in grams)

| Component | Ex. 1 | Ex. 2 | IE-3 | IE-4 | Ex. 5 | Ex. 6 | Ex. 7 |
|---|---|---|---|---|---|---|---|
| CN9101 | 1.3988 | — | — | — | 1.3951 | 1.3988 | 1.3786 |
| CN9102 | — | 1.3965 | — | — | — | — | — |
| DAPH | — | — | 1.3827 | — | — | — | — |
| PB-B1000 | — | — | — | 0.9150 | — | — | — |
| PTMP | 1.4162 | 1.3872 | 1.3860 | 1.9480 | 1.4011 | 1.4162 | 1.3812 |
| HET | — | — | — | 0.0606 | — | — | — |
| Powder 1 | 1.50 | 2.50 | 2.50 | 1.52 | 2.50 | 1.50 | 1.50 |
| BPO | 0.1084 | — | — | 0.1074 | — | 0.1084 | — |
| TBPB | — | 0.2026 | 0.2112 | — | 0.2023 | — | 0.2586 |

TABLE 3
Composition of Various Examples and Comparative
Examples (values in grams)

| Component | Ex. 8 | Ex. 9 | IE-10 | Ex. 11 | Ex. 12 | Ex. 13 |
|---|---|---|---|---|---|---|
| CN9101 | 1.3815 | 1.3803 | 1.3780 | 1.4057 | 1.3881 | 1.3734 |
| PTMP | 1.3854 | 1.3703 | 1.3732 | 1.3793 | 1.3804 | 1.4023 |
| Styrene | — | — | — | 0.1077 | — | — |
| VAc | — | — | — | — | 0.1053 | 0.1154 |
| AA | 0.0516 | — | — | — | — | — |
| 10-UDA | — | 0.0533 | — | — | — | 0.0361 |
| ET3N | — | — | 0.0486 | — | — | — |
| Powder 1 | 2.50 | 2.50 | 2.50 | 2.50 | 2.50 | 2.50 |
| BPO | 0.2090 | — | — | — | — | — |
| TBPB | — | 0.2013 | 0.2042 | 0.2013 | 0.1984 | 0.2000 |

Using the Gel Time, Curing Time and Tackiness test methods, the curing behaviors of the composition were determined. Results are shown in Table 4.

TABLE 4

| | | Time to Achieve Curing | Surface Tackiness |
|---|---|---|---|
| | | into a Completely | after Coating |
| | Gel time | Solidified Coating | Completely |
| Sample | (minutes) | (minutes) | Solidified |
| Ex. 1 | 2-3 | 18-20 | Not Tacky. |
| Ex. 2 | 2.5-4 | 20-25 | Slightly Tacky. |
| IE-3 | >90 | Overnight | Tacky. |
| IE-4 | No drying | No curing | Tacky. |
| EX. 5 | 2-3 | 18-20 | Slightly Tacky. |
| Ex. 6 | 3-4 | 20-22 | Slightly Tacky. |
| Ex. 7 | 2.5-4 | 30-50 | Not Tacky. |
| Ex. 8 | 4-5 | 30-50 | — |
| Ex. 9 | 2-3 | 5-10 | Not Tacky. |
| IE-10 | 12-18 | 50-90 | Tacky. |
| | for thick part; | | |
| | 12-30 | | |
| | for thin part | | |
| Ex. 11 | 2.5-3.5 | 25-30 | Slightly Tacky |
| Ex. 12 | 2.5-3.5 | 25-30 | Tacky. |
| Ex. 13 | 2-3 | 15 | Not Tacky. |

Various modifications and alterations of this disclosure may be made by those skilled the art without departing from the scope and spirit of the disclosure, and it should be understood that this invention is not to be unduly limited to the illustrative embodiments set forth herein.

1. A composition comprising:
a polythiol comprising more than one thiol group;
an allylic resin comprising more than one allyl group;
inorganic filler; and
an adhesion promoter comprising at least one acid group and at least one carbon-carbon double bond or carbon-carbon triple bond.

2. The composition of claim 1, wherein the polythiol comprises more than two thiol groups, the allylic resin comprises more than two allyl groups, or both the polythiol and the allylic resin comprise more than two thiol or allyl groups, respectively.

3. The composition of claim 1, wherein the polythiol comprises ester groups.

4. The composition of claim 1, wherein the polythiol has a molecular weight of up to 500 grams per mole.

5. The composition of claim 1, wherein the allylic resin is an allylic functional aliphatic oligomer, an allylic functional polyurethane, an allylic functional polyester, an allylic functional polyether, a diallyl phthalate resin, or an allylic functional polythioether.

6. The composition of claim 1, wherein the inorganic filler comprises at least one of ceramic beads, silica, hollow ceramic elements, alumina, zirconia, mica, dolomite, wollastonite, fibers, talc, calcium carbonate, or clay.

7. The composition of claim 1, wherein the composition is substantially free of a tertiary amine.

8. The composition of claim 1, wherein the adhesion promoter comprising at least one acid group and at least one carbon-carbon double bond or carbon-carbon triple bond comprises at least one of a carboxylic acid having at least six carbon atoms and one, two, or three double bonds, acrylic acid, itaconic acid, or beta-carboxyethyl acrylate.

9. The composition of claim 1, further comprising at least one of a reactive diluent or a radical inhibitor.

10. The composition of claim 1, wherein the composition is substantially free of styrene.

11. The composition of claim 1, wherein the composition is substantially free of photoinitiator.

12. The composition of claim 1, wherein a number of the thiol groups is within 20 percent of a number of the allyl groups.

13. The composition of claim 1, further comprising an organic peroxide or organic hydroperoxide.

14. (canceled)

15. A method of repairing a damaged surface, the method comprising:
combining a composition with at least one of an organic peroxide or an organic hydroperoxide;
applying the composition including at least one of the organic peroxide or the organic hydroperoxide to the damaged surface; and
curing the composition on the damaged surface to provide a cured composition, wherein the composition comprises a polythiol having more than one thiol group, an allylic compound having more than one allyl group, and inorganic filler, wherein a number of the thiol groups is within 20 percent of a number of the allyl groups, and wherein at least one of the polythiol or the allylic compound has more than two thiol or allyl groups, respectively.

16. The method of claim 15, wherein the damaged surface is on at least a portion of a vehicle.

17. The method of claim 15, wherein curing is carried out at room temperature.

18. The method of claim 15, further comprising sanding the cured composition.

19. The composition of claim 8, wherein the adhesion promoter comprises 10-undecenoic acid.

20. The composition of claim 1, further comprising a monofunctional reactive diluent, wherein the monofunctional reactive diluent comprises vinyl acetate.

21. The composition of claim 1 packaged as a two-part body repair composition, wherein a first part comprises the composition and a second part comprises an organic peroxide or organic hydroperoxide.
